(19) United States
(12) Patent Application Publication
(10) Pub. No.: US 2020/0334530 A1
(43) Pub. Date: Oct. 22, 2020

(54) DIFFERENTIABLE NEUROMODULATED PLASTICITY FOR REINFORCEMENT LEARNING AND SUPERVISED LEARNING TASKS

(71) Applicant: Uber Technologies, Inc., San Francisco, CA (US)

(72) Inventors: Thomas Miconi, San Francisco, CA (US); Kenneth Owen Stanley, San Francisco, CA (US); Jeffrey Michael Clune, San Francisco, CA (US)

(21) Appl. No.: 16/850,011

(22) Filed: Apr. 16, 2020

Related U.S. Application Data
(60) Provisional application No. 62/836,545, filed on Apr. 19, 2019.

(51) Int. Cl. G06N 3/08; G06N 3/04

(52) U.S. Cl. CPC G06N 3/08; G06N 3/0454; G06N 3/0445

(57) ABSTRACT

A system uses neural networks for applications such as navigation of autonomous vehicles or mobile robots. The system uses a trained neural network model that comprises fixed parameters that remain unchanged during execution of the model, plastic parameters that are modified during execution of the model, and nodes that generate outputs based on the inputs, fixed parameters, and the plastic parameters. The system provides input data to the neural network model and executes the neural network model. The system updates the plastic parameters of the neural network model by adjusting the rate at which the plastic parameters update over time based on at least one output of a node.

### CROSS REFERENCE TO RELATED APPLICATIONS

This application claims the benefit of U.S. Provisional Application No. 62/836,545, filed Apr. 19, 2019, which is incorporated by reference in its entirety.

### BACKGROUND

### 1. Technical Field

The subject matter described generally relates to artificial intelligence and machine learning, and in particular to machine learning based models such as neural networks that can change their weights after they have been trained.

### 2. Background Information

Artificial intelligence techniques such as machine learning are used for performing complex tasks, for example, natural language processing, computer vision, speech recognition, bioinformatics, recognizing patterns in images, and so on. Examples of such techniques include reinforcement learning and supervised learning. Machine learning models such as neural network models are used for solving problems such as translation of natural languages, object recognition in images. Neural network models are used for solving problems such as navigating a robot through an obstacle course, navigating an autonomous vehicle or self-driving vehicle through a city, performing word-level language modeling, signal processing, processing sensor data, object recognition in images, and so on.

Conventional neural network models, including fixed-weight networks, do not modify the connectivity of their nodes after training is completed. Conventional neural network models for handling temporal information face an issue of catastrophic forgetting, where a neural network model overwrites a previously learned skill and/or task while learning a new skill and/or task. Many challenging real-world problems require the ability to learn new skills and/or tasks from experiences over time, without completely overwriting the previously learned skills and/or tasks. As a result, conventional techniques for solving such problems either perform poorly or fail to perform such tasks. Additionally, conventional techniques that deal with temporally extended tasks utilize evolution and are difficult to scale to large neural networks for handling complex tasks.

### SUMMARY

Systems and methods are disclosed herein for controlling moveable apparatuses such as self-driving vehicles or mobile robots using neural networks. A system receives sensor data from sensors mounted on a moveable apparatus. The sensor data describes the environment of the moveable apparatus. A trained neural network model is loaded. The neural network model comprises (1) a plurality of fixed parameters that remain unchanged during execution of the trained neural network, (2) a plurality of plastic parameters that are modified during execution of the trained neural network model, (3) a plurality of nodes, each node generating an output based on inputs to the neural network model, the fixed parameters, and the plastic parameters. At least one node generates an output based on at least one weighted output generated by other nodes of the plurality of nodes. The system encodes sensor data to generate input data for the neural network model and provides the input data to the neural network model. The system executes the trained neural network model to generate output results, based on the input data. The system updates the plastic parameters of the neural network model by adjusting a rate at which the plastic parameters update over time based on at least one output of a node generated by the executing the trained neural network model. The system generates signals for controlling the moveable apparatus based on the output results.

According to other embodiments, the systems and methods use neural networks for other applications. The system loads a trained neural network model comprising (1) a plurality of fixed parameters that remain unchanged during execution of the trained neural network, (2) a plurality of plastic parameters that are modified during execution of the trained neural network model, and (3) a plurality of nodes, each node generating an output based on the one or more inputs, the plurality of fixed parameters, and the plurality of plastic parameters, wherein at least one node of the plurality of nodes generates an output further based on at least one weighted output generated by one or more other nodes. The system provides an input data to the neural network model and executes the trained neural network to generate output results. The output results correspond to at least one of: a recognized pattern in the input data, a decision based on the input data, or a prediction based on the input data. The system updates the plastic parameters of the neural network model by adjusting the rate at which the plastic parameters update over time based on at least one output of a node generated by executing the trained neural network.

### BRIEF DESCRIPTION OF THE DRAWINGS

FIG. 1 illustrates a networked computing environment in which differentiable neuromodulated plasticity (DNP) may be used, according to an embodiment.

FIG. 2 illustrates a system for training and using DNP-based models, according to one embodiment.

FIG. 3 illustrates the system architecture of a neural network execution module, according to one embodiment.

FIG. 4 is the overall process for executing a neural network model, according to one embodiment.

FIG. 5 is a diagram illustrating an example of a component of a neuromodulatory signal and a plastic component of node output for a corresponding node of a DNP-based neural network model over a series of executions of the model, according to one embodiment.

FIGS. 6A-6B illustrating the details of processes for the execution of a DNP-based model, according to various embodiments.

FIG. 7 is a high-level block diagram illustrating an example of a computer suitable for use in the system environment of FIGS. 1-2, according to one embodiment.

The Figures (FIGS.) and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures. It is noted that wherever practicable similar or like reference numbers are used in the figures to indicate similar or like functionality.

### DETAILED DESCRIPTION

Differentiable neuromodulated plasticity (DNP) in neural network models refers to the ability of a neural network to self-modify the interconnectivity between individual nodes of a neural network model as a function of ongoing activity. This ability allows the neural network model to selectively modify itself, filtering irrelevant events while learning skills and/or tasks from important events. For plastic neural networks, one or more nodes of the neural network generates a node output partially based on a weighted node output of at least one other node in the neural network. Nodes in neural networks with differentiable plasticity have plastic weights of the node outputs of the other nodes in the neural network that are trainable, allowing for complex learning strategies not possible with uniform plasticity, where the plastic weights are not trainable.

A DNP-based neural network model modulates the plastic weights on a moment-to-moment basis based on an output of a neuromodulatory signal, referred to herein as M(t), controlled by the DNP-based neural network. In some embodiments, the output of M(t) includes a simple scalar output. In other embodiments, the output of M(t) is modified by a learned vector of weights. For example, the output of M(t) may be modified by a vector of weights including one weight for each connection between nodes of the DNP-based neural network model. In some embodiments, the DNP-based neural network model receives input data including a reward input. The DNP-based neural network model may modulate M(t) in response to receiving the reward input.

According to an embodiment, systems for executing a DNP-based neural network model can learn tasks, training the DNP-based neural network model to self-modify its weights during the execution. The DNP-based neural network model can be trained with gradient descent, instead of evolution, enabling the optimization of large-scale self-modifying neural networks. Embodiments of the invention show technical improvement over conventional techniques that generate and execute self-modifying neural networks. For example, conventional techniques suffer from catastrophic forgetting and overwrite a previously learned skill and/or task while learning a new skill and/or task whereas machine learning models according to embodiments of the invention have a resistance against catastrophic forgetting. Accordingly, neural network models according to various embodiments do not overwrite a previously learned skill and/or task while learning a new skill and/or task. Compared to conventional techniques, neural network models according to various embodiments are scalable and can generate significantly larger DNP-based networks through training with gradient descent, and improved ability to learn tasks. The DNP-based neural network model according to embodiments of the invention also store a state of the DNP-based neural network model with weight changes, in addition to storing hidden states of the DNP-based neural network model.

### Overall System Environment

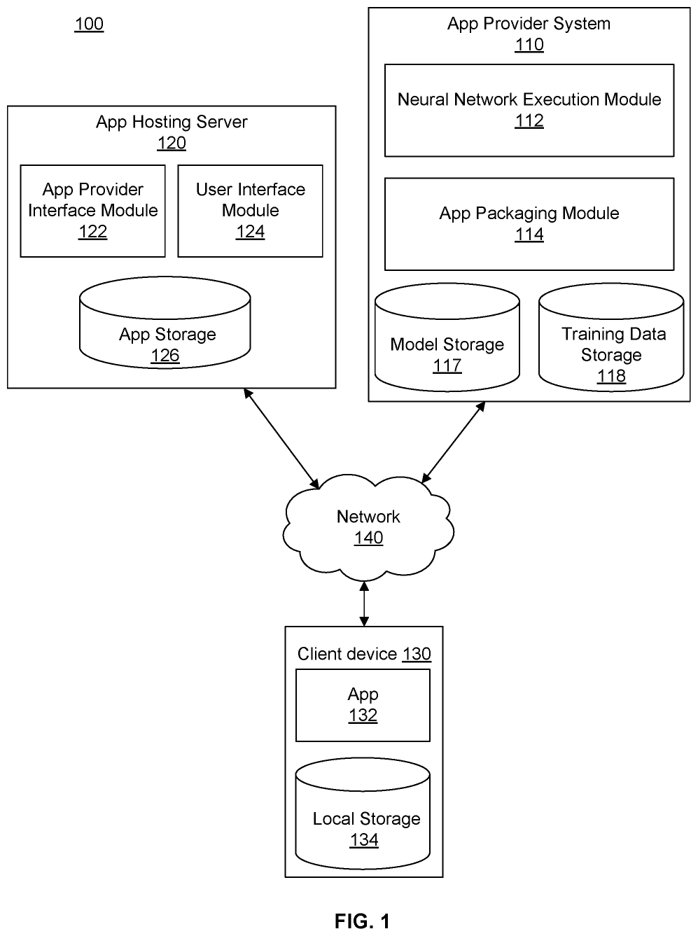

FIG. 1 illustrates a networked computing environment in which differentiable neuromodulated plasticity (DNP) may be used, according to an embodiment. In the embodiment shown in FIG. 1, the networked computing environment 100 includes an application provider system 110, an application hosting server 120, and a client device 130, all connected via a network 140. An application is also referred to herein as an app. Although only one client device 130 is shown, in practice many (e.g., thousands or even millions of) client devices may be connected to the network 140 at any given time. In other embodiments, the networked computing environment 100 contains different and/or additional elements. In addition, the functions may be distributed among the elements in a different manner than described. For example, the client device 130 may obtain an application 132 directly from the application provider system 110, rather than from the application hosting server 120.

The application provider system 110 is one or more computer systems with which the provider of software develops that software. Although the application provider system 110 is shown as a single entity, connected to the network 140, for convenience, in many cases it will be made up from several software developer's systems (e.g., terminals) which may or may not all be network-connected.

In the embodiment shown in FIG. 1, the application provider system 110 includes a neural network execution module 112, an application packaging module 114, a model storage 117, and training data storage 118. In other embodiments, the application provider system 110 contains different and/or additional elements. In addition, the functions may be distributed among the elements in a different manner than described.

The neural network model execution module 112 trains models using processes and techniques disclosed herein. The neural network model execution module 112 stores the trained models in the model storage 117. The app packaging module 114 takes a trained model and packages it into an app to be provided to client devices 130. Once packaged, the app is made available to client devices 130 (e.g., via the app hosting server 120).

The model storage 117 and training data storage 118 include one or more computer-readable storage-media that are configured to store models, for example, neural networks and training data, respectively. Although they are shown as separate entities in FIG. 1, this functionality may be provided by a single computer-readable storage-medium (e.g., a hard drive).

The app hosting server 120 is one or more computers configured to store apps and make them available to client devices 130. In the embodiment shown in FIG. 1, the app hosting server 120 includes an app provider interface module 122, a user interface module 124, and app storage 126. In other embodiments, the app hosting server 120 contains different and/or additional elements. In addition, the functions may be distributed among the elements in a different manner than described.

The app provider interface module 122 adds the app (along with metadata with some or all of the information provided about the app) to the app storage 126. In some cases, the app provider information module 122 also performs validation actions, such as checking that the app does not exceed a maximum allowable size, scanning the app for malicious code, verifying the identity of the provider, and the like.

The user interface module 124 provides an interface to client devices 130 with which apps can be obtained. In one embodiment, the user interface module 124 provides a user interface using which the users can search for apps meeting various criteria from a client device 130. Once users find an app they want (e.g., one provided by the app provider system 110), they can download them to their client device 130 via the network 140.

The app storage 126 include one or more computer-readable storage-media that are configured to store apps and associated metadata. Although it is shown as a single entity in FIG. 1, the app storage 126 may be made up from several storage devices distributed across multiple locations. For example, in one embodiment, app storage 126 is provided by a distributed database and file storage system, with download sites located such that most users will be located near (in network terms) at least one copy of popular apps.

The client devices 130 are computing devices suitable for running apps obtained from the app hosting server 120 (or directly from the app provider system 110). The client devices 130 can be desktop computers, laptop computers, smartphones, PDAs, tablets, or any other such device. In an embodiment, a client device represents a computing system that is part of a larger apparatus, for example, a moveable apparatus, a robot, a self-driving vehicle, a drone, and the like. In the embodiment shown in FIG. 1, the client device 130 includes an application 132 and local storage 134. The application 132 is one that uses a machine learning model to perform a task, such as one created by the application provider system 110. The local data store 134 is one or more computer readable storage-media and may be relatively small (in terms of the amount of data that can be stored). Thus, the use of a compressed neural network may be desirable, or even required.

The network 140 provides the communication channels via which the other elements of the networked computing environment 100 communicate. The network 140 can include any combination of local area and/or wide area networks, using both wired and/or wireless communication systems. In one embodiment, the network 140 uses standard communications technologies and/or protocols. For example, the network 140 can include communication links using technologies such as Ethernet, 802.11, 3G, 4G, etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 140 may be represented using any suitable format, such as hypertext markup language (HTML) or extensible markup language (XML). In some embodiments, all or some of the communication links of the network 140 may be encrypted using any suitable technique or techniques.

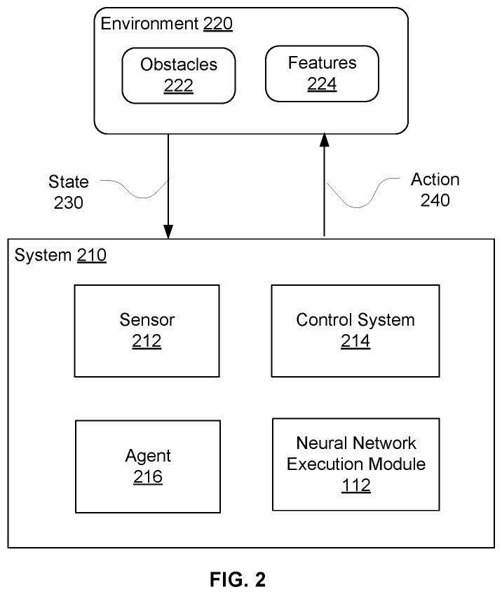

FIG. 2 illustrates a system for training and using DNP-based models, according to one embodiment. The system 210 shown in FIG. 2 is a computing system that may be part of an apparatus or device, for example, a self-driving car or a robot. The system 210 may include one or more client devices 130. In some embodiments, the client device 130 is part of a moveable apparatus. The environment 220 represents the surroundings of the system. For example, the environment 220 may represent a geographical region through which a self-driving car is travelling. Alternatively, the environment 220 may represent a maze or an obstacle course through which a robot is navigating. As another example, the environment 220 may represent a setup of a video game that the system 210 is playing, for example, an ATARI game.

The environment 220 may comprise objects that may act as obstacles 222 or features 224 that are detected by the system 210. The system 210 comprises one or more sensors 212, a control system 214, an agent 216, and a neural network execution module 112. The system 210 uses the sensor 212 to sense the state 230 of the environment 220. In some embodiments the sensor is a camera mounted on a moveable apparatus. The agent 216 performs actions 240. The actions 240 may cause the state 230 of the environment to change.

The sensor 212 may be a camera that captures images of the environment. Other examples of sensors include a lidar, an infrared sensor, a motion sensor, a pressure sensor, or any other type of sensor that can provide information describing the environment 220 to the system 210. The agent 216 uses models trained by the neural network execution module 112 to determine what action to take. The agent 216 sends signals to the control system 214 for taking the action 240. Examples of sensors include a lidar, a camera, a global positioning system (GPS), and an inertial measurement unit (IMU).

For example, the sensors of a robot may identify an object. The agent 216 of the robot invokes a model to determine a particular action to take, for example, to move the object. The agent 216 of the robot sends signals to the control system 214 to move the arms of the robot to pick up the object and place it elsewhere. Similarly, a robot may use sensors to detect the obstacles surrounding the robot to be able to maneuver around the obstacles.

As another example, a self-driving car may capture images of the surroundings to determine a location of the self-driving car. As the self-driving car drives through the region, the location of the car changes and so do the surroundings of the car change. As another example, a system playing a game, for example, a system playing an ATARI game may use sensors to capture an image representing the current configuration of the game and make some move that causes the configuration of the game to change.

As another example, the system 210 may be part of a drone. The system navigates the drone to deliver an object, for example, a package to a location. The model helps the agent 216 to determine what action to take, for example, for navigating to the right location, avoiding any obstacles that the drone may encounter, and dropping the package at the target location.

As another example, the system 210 may be part of a facility, for example, a chemical plant, a manufacturing facility, or a supply chain system. The sensors monitor equipment used by the facility, for example, monitor the chemical reaction, status of manufacturing, or state of entities/products/services in the supply chain process. The agent 216 takes actions, for example, to control the chemical reaction, increase/decrease supply, and so on.

An action represents a move or an act that the agent can make. An agent selects from a set of possible actions. For example, if the system is configured to play video games, the set of actions may include running right or left, jumping high or low, and so on. If the system is configured to trade stocks, the set of actions includes buying, selling or holding any one of an array of securities and their derivatives. If the system is part of a drone, the set of actions includes increasing speed, decreasing speed, changing direction, and so on. If the system is part of a robot, the set of actions includes walking forward, turning left or right, climbing, and so on. If the system is part of a self-driving vehicle, the set of actions includes driving the vehicle, stopping the vehicle, accelerating the vehicle, turning left/right, changing gears of the vehicle, changing lanes, and so on.

A state represents a potential situation in which an agent can find itself, i.e., a configuration in which the agent (or the system/apparatus executing the agent, for example, the robot, the self-driving car, the drone, etc.) is in relation to its environment or objects in the environment. In an embodiment, the representation of the state describes the environment as observed by the agent. For example, the representation of the state may include an encoding of sensor data received by the agent, i.e., the state represents what the agent observes in the environment. In some embodiments, the representation of the state encodes information describing an apparatus controlled by the agent, for example, (1) a location of the apparatus controlled by the agent, e.g., (a) a physical location such as a position of a robot in an obstacle course or a location of a self-driving vehicle on a map, or (b) a virtual location such as a room in a computer game in which a character controlled by the agent is present; (2) an orientation of the apparatus controlled by the agent, e.g., the angle of a robotic arm; (3) the motion of the apparatus controlled by the agent, e.g., the current speed/acceleration of a self-driving vehicle, and so on.

The representation of the state depends on the information that is available in the environment to the agent. For example, for a robot, the information available to an agent controlling the robot may be the camera images captured by a camera mounted on the robot. For a self-driving vehicle, the state representation may include various type of sensor data captured by sensors of the self-driving vehicles including camera images captured by cameras mounted on the self-driving vehicle, lidar scans captured by lidars mounted on the self-driving vehicle, and so on. If the agent is being trained using a simulator, the state representation may include information that can be extracted from the simulator that may not be available in real-world, for example, the position of the robot even if the position may not be available to a robot in real world. The availability of additional information that may not be available in real world is utilized by the explore phase to efficiently find solutions to the task.

Objects in the environment may be physical objects such as obstacles for a robot, other vehicles driving along with a self-driving vehicle. Alternatively, the objects in the environment may be virtual objects, for example, a character in a video game or a stock that can be bought/sold. The object may be represented in a computing system using a data structure.

A reward is the feedback by which the system measures the success or failure of an agent's actions. From a given state, an agent performs actions that may impact the environment, and the environment returns the agent's new state (which resulted from acting on the previous state) as well as rewards, if there are any. Rewards evaluate the agent's action.

A policy represents the strategy that the agent employs to determine the next action based on the current state. A policy maps states to actions, for example, the actions that promise the highest reward. A trajectory represents a sequence of states and actions that influence those states.

In an embodiment, an agent uses a DNP-based neural network to select the action to be taken. For example, the agent may use a DNP-based neural network to process the sensor data, for example, a representation of the environment surrounding the sensor. An example of a representation of the environment surrounding a sensor is a camera image or lidar scan taken by sensors (such as camera and lidar) of a self-driving vehicle or a mobile robot. In an embodiment, a convolutional neural network is configured to select the action to be performed in a given situation. The DNP-based neural network may rank various actions by assigning a score to each action and the agent selects the highest scoring action. For example, the action may determine the direction in which a mobile robot moves in an obstacle course or a self-driving vehicle moves in traffic.

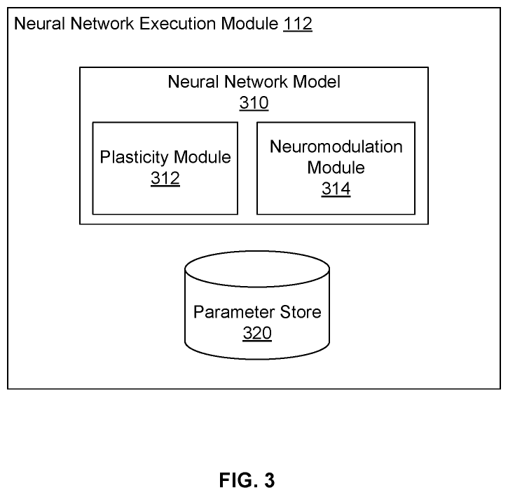

FIG. 3 illustrates the system architecture of a neural network execution module, according to one embodiment. The neural network execution module 112 comprises a neural network model 310 and a parameter store 320. In some embodiments, the neural network model 310 is one selected from a group including: a long short-term memory (LSTM) model, a recurrent neural network (RNN) model, and a feedforward neural network. Other embodiments may include other types of neural network models and more of fewer modules than those shown in FIG. 3. Functions indicated as being performed by a particular module may be performed by other modules than those indicated herein.

The neural network model 310 includes a plurality of nodes, each of which generates a node output based on some combination of one or more inputs to the neural network model 310, values of a set of fixed parameters accessed in the parameter store 320, and values of a set of plastic parameters accessed in the parameter store 320. The node outputs of the nodes are used to generate the output of the neural network model 310. The fixed parameters are determined and stored in the parameter store 320 during an initial pre-training of the neural network execution model 310. The fixed parameters are not updated during executions of the neural network model 310, according to some embodiments. The fixed parameters may include weights for the one or more inputs of the neural network model 310 that are used to generate the output. The plastic parameters include a plurality of plastic weights for each node of the neural network model 310, according to some embodiments. At least one node, referred to herein as a plastic node, of the neural network model 310 receives a node output from one or more other nodes and generates a node output based on the output from the one or more other nodes. The weight of the node output of a given node in generating the node output for the plastic node is determined by one of the plastic weights. As such, the plastic parameters effectively control the interconnectivity of the nodes of the neural network 310.

The neural network model 310 is a DNP-based neural network model that selectively modulates its own plastic weights on a moment-to-moment basis for each execution of the neural network model 310. The neural network model 310 comprises a plasticity module 312 and a neuromodulation module 314. The plasticity module 312 determines plastic parameters of the neural network model 310 and stores the plastic parameters in the parameter store 320. In some embodiments, the plastic parameters are optimized using gradient descent at an execution time of the neural network model 310. Accordingly, the system determines at execution time, the direction of steepest descent and updates the plastic parameters to optimize a cost function.

The neural network model 310 accesses the plastic parameters in the parameter store 320 and generates an output partially based on the plastic parameters. During an execution of the neural network model 310, the plasticity module 312 also updates the plastic parameters in the parameter store 320 based on a neuromodulatory signal M(t) received from the neuromodulation module 314. The plastic parameters include a plurality of plastic weights for each node of the neural network model 310, according to some embodiments. The plurality of plastic weights are used in determining a node output of at least one plastic node of the neural network model 310, such that the node output of the at least one plastic node of the neural network is partially based on node outputs of the other nodes weighted by the plastic weights.

The neuromodulation module 314 determines the neuromodulatory signal M(t) provided to the plasticity module 312 for updating the plastic parameters of the neural network model 310 based on anode output of at least one node of the neural network model 310. M(t) is used to modify the rate at which the plasticity module 312 updates and/or modifies the plastic parameters of the neural network 310 during each execution of the neural network model 310. By doing this, the neuromodulation module 314 may selectively modulate the effect on updating of the plastic parameters by the plasticity module 312 due to events that occur during executions of the neural network model 310. Accordingly, the neuromodulation module 314 enables the neural network 310 to selectively modify itself.

### Overall Process

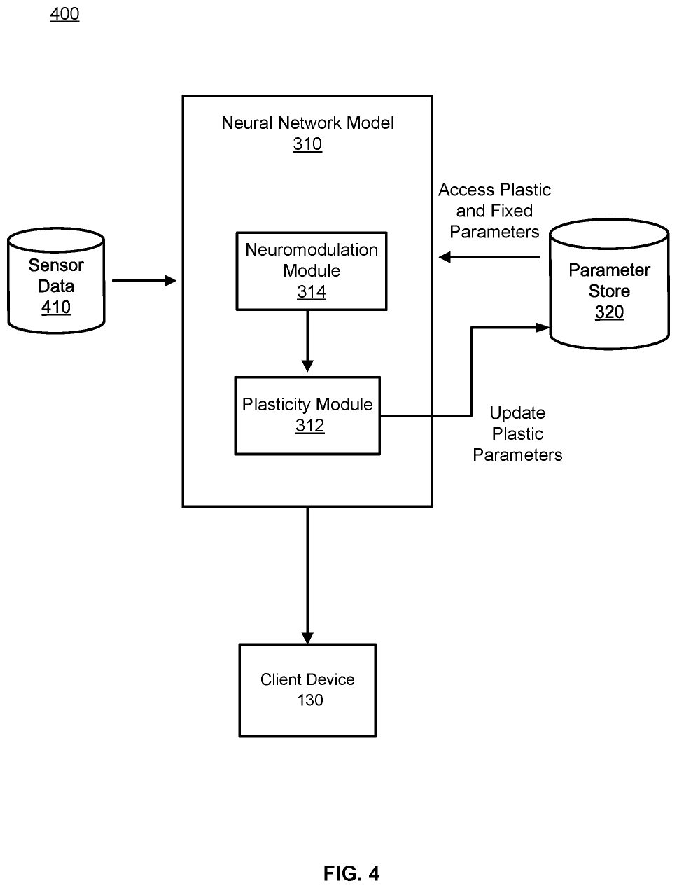

FIG. 4 is the overall process for executing a neural network model, according to one embodiment. In an execution, the neural network model 310 receives sensor data 410 captured by the system 210 and generates an output that may be provided to a client device 130. In some embodiments, the sensor data includes images captured by a camera mounted on a moveable apparatus. The moveable apparatus may be a robot configured to navigate through an obstacle course or a self-driving vehicle navigating through traffic. In generating the output, each of the plurality of nodes of the neural network model 310 generates a node output which is used to generate the output of the neural network model 310. The output includes instructions for an action to be performed by the system 210, according to some embodiments. For example, the sensor data 410 may be a plurality of images captured by the sensor 212, and the generated output may include navigation instructions for a self-driving car (or autonomous vehicle) to drive the vehicle, stop the vehicle, accelerate the vehicle, turn left/right, change gears of the vehicle, change lanes, and so on.

The neural network model 310 continuously learns to perform tasks over time, in response to executions of the neural network model 310 after an initial training of the neural network model 310. In some embodiments, the neural network model 310 may be trained using machine learning techniques on a training set of data. After the training has concluded, the neural network model 310 is executed, receiving the sensor data 410, accessing plastic and fixed parameters in the parameter store 320, generating outputs, and updating the plastic parameters in the parameter store 320. In an embodiment, the neural network model 310 is configured to receive the sensor data 410 and determine an action 240 to be performed based on the sensor data 410 as well as the current state of the agent 216. The neural network model 310 may derive the current state of the environment 220 based on the sensor data 410 and determine the next action based on the current state 230 of the environment 220 and the current state of the agent 216.

During an execution of the neural network model 310, the neural network model 310 receives sensor data 410 as an input. The neural network model 310 accesses plastic parameters and fixed parameters in the parameter store 320 and generates an output based on the sensor data, values of the plastic parameters, and values of the fixed parameters. The neuromodulation module 314 receives node outputs generated by one or more nodes of the neural network model and generates a neuromodulatory signal M(t) based on the received node outputs. The neuromodulatory signal M(t) is a function of time such that the output of the function can change over time, for example, the value of M(T) can be different during different executions of the neural network model 310. Accordingly, the neuromodulatory signal M(t) can have a value V1 during an execution n1 and a different value V2 during another execution n2. The nodes providing the node outputs to the neuromodulation module 314 may be trained by machine learning techniques, according to some embodiments. As a result, the neural network model 310 may be trained to modify itself.

The plasticity module 312 receives M(t) from the neuromodulation module 314 and updates the plastic parameters in the parameter store 320 based on M(t). The plasticity module modifies the plastic parameters when updating the plastic parameters at a rate that depends on M(t). In some embodiments, the neuromodulatory signal M(t) is a vector with each component of the vector corresponding to at least one node of the neural network model 310. In an embodiment, the plasticity module modifies the plastic parameters when updating the plastic parameters at a rate that is directly related to a magnitude of M(t). For example, if a component of M(t) received by the plasticity module 312 is zero during an execution of the neural network model 310, the plasticity module 312 may not change a value of a corresponding plastic parameter when updating the plastic parameters. Additionally, if a component of M(t) received by the plasticity module 312 has a large magnitude, the plasticity module 312 may modify a value of a corresponding plastic parameter by a large amount, proportional to the magnitude of the component of M(t).

In some embodiments, the rate at which the plastic parameters are updated over time is adjusted based on past executions of the neural network model 310. Accordingly, the rate at which the plastic parameters are updated is a weighted aggregate of values of neuromodulatory signal M(t) corresponding to a plurality of past executions, for example, the most recent N executions, where N>0. In further embodiments, the past executions of the neural network model 310 are weighted based on a trainable decay factor when adjusting the rate at which the plastic parameters are updated. The trainable decay factor may, for example, have lower weights for past executions that are not as recent.

### Differentiable Neuromodulation of Plasticity

In some embodiments, the neural network model 310 has a Hebbian plasticity framework, where each connection between two nodes is augmented with a Hebbian plastic component that grows and decays automatically as a result of ongoing executions of the neural network model 310. Each connection of the neural network model 310 has fixed parameters and plastics parameters. An output of a j-th node of the neural network model 310 is represented by the following equation:

xⱼ(t)=σ{Σ_{i∈inputs to j}(w_{i,j}+α_{i,j}Hebb_{i,j}(t))xᵢ(t−1)} (1)

where t is a timestep in an execution and/or executions of the neural network model 310, xⱼ is a node output of the j-th node, xᵢ is a node output of the i-th node, σ is a nonlinearity, w_{i,j} is a fixed parameter of the connection between the i-th node and the j-th node, and α_{i,j} is a plastic parameter that scales the magnitude of a plastic component of the connection, the plastic component including Hebb_{i,j}(t). Hebb_{i,j}(t) is a Hebbian trace which accumulates the product of previous and current activity in the neural network model 310. In some embodiments, U is a tan h function. Accordingly, system determines xⱼ(t), the output of the j-th node of the neural network model 310 as follows. The system scales the Hebbian trace Hebb_{i,j}(t) by the plastic parameter α_{i,j} and adds the fixed parameter w_{i,j} to the scaled value of the Hebbian trace to determine a weight term. The system weighs xᵢ(t−1), the node output of the j-th node determined for the (t−1) timestep using the weight term. The system aggregates the scaled node outputs for the (t−1) timestep and applies the nonlinearity function a to the aggregate value.

In some embodiments, the Hebbian trace is initialized to zero at the beginning of each episode of the neural network model 310, a duration of an episode including a plurality of executions of the neural network model 310. In other embodiments, a duration of an episode is exactly one execution of the neural network model 310. The Hebbian trace is then updated during an episode and is an episodic quantity. In contrast, w_{i,j} and α_{i,j} are not modified during or between an episode.

In some embodiments, the neural network model 310 uses simple modulation of the Hebbian plasticity, such that the Hebbian trace is represented by the following equation:

Hebb_{i,j}(t+1)=Clip(Hebb_{i,j}(t)+M_{i,j}(t)xᵢ(t−1)xⱼ(t)) (2)

where M_{i,j}(t) is the neuromodulatory signal for the connection between the i-th node and the j-th node and Clip(y) is any clipping function that constrains the Hebbian trace to a range of −1 to 1. Accordingly, the system determines product of the node outputs xᵢ(t−1) and xⱼ(t) and M_{i,j}(t), the neuromodulatory signal for the connection between the i-th node and the j-th node. The system adds the product value to the Hebbian trace value Hebb_{i,j}(t) between the i-th node and the j-th node. The system applies the clipping function to the sum value to constrain the result to a predefined range, for example, −1 to 1. The clipping function prevents instability of the neural network model 310 with Hebbian plasticity. In some embodiments, the clipping function is a hard clip that constrains the Hebbian trace to 1 if equation 2 is greater than 1 and constrains the Hebbian trace to −1 if equation 2 is less than −1. In this case, M(t) determines the episodic learning rate of the plastic connection between the i-th node and the j-th node, represented by xᵢ(t−1)xⱼ(t), which determines how quickly new information is incorporated into the plastic component. M(t) is based on the node output of at least one node of the neural network model 310.

In other embodiments, the neural network model 310 uses retroactive neuromodulation of the Hebbian plasticity, such that the Hebbian trace is represented by the following equations:

Hebb_{i,j}(t+1)=Clip(Hebb_{i,j}(t)+M_{i,j}(t)E_{i,j}(t)) (3)

E_{i,j}(t+1)=(1−η)E_{i,j}(t)+ηxᵢ(t−1)xⱼ(t) (4)

where E_{i,j} is an eligibility trace of the connection between the i-th node and the j-th node and η is a trainable decay factor. In some embodiments, E_{i,j} is an exponential average of the Hebbian product of previous and current executions of the neural network model 310. Here, the Hebbian trace accumulates the eligibility trace, with the eligibility trace gated by the current value of M(t). In the case of retroactive neuromodulation, the eligibility trace is a fast decaying signal which signifies the potential to change the plastic parameters of the neural network model 310. The neuromodulatory signal M(t) does not directly modify the instantaneous learning rate of the plastic connection, but modulates the weight of the eligibility trace in updating the plastic parameters of the neural network model 310. For example, if M(t) is zero for a given timestep, the eligibility trace does not factor into the updating of the plastic parameters for that timestep.

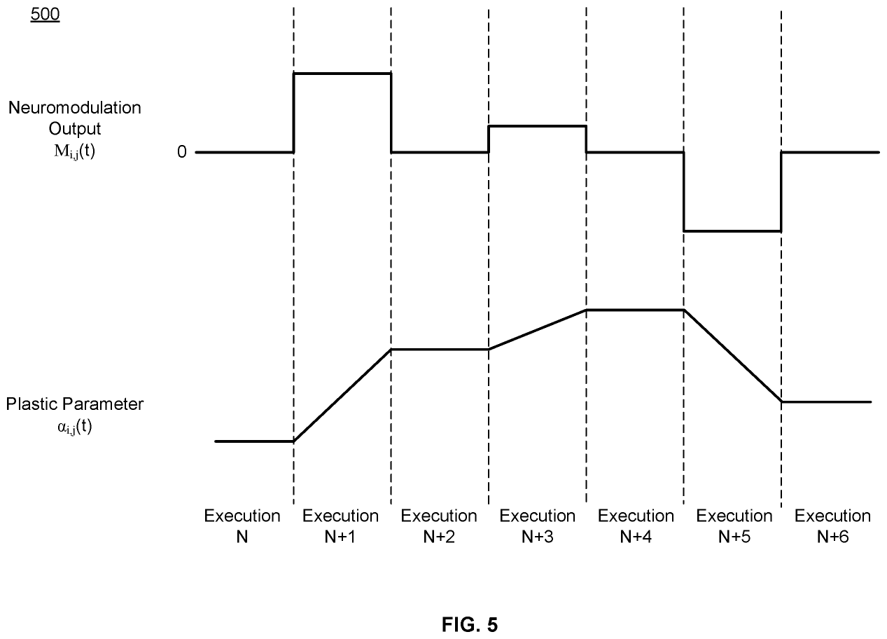

FIG. 5 is a diagram illustrating an example of a component of a neuromodulatory signal and a plastic parameter of node output for a corresponding node of a DNP-based neural network model over a series of executions of the model, according to one embodiment. The component of the neuromodulatory signal M_{i,j}(t) corresponds to a connection between an i-th node and a j-th node. The plastic parameter α_{i,j}(t) corresponds to the weight of a node output from the j-th node with respect to generating a node output for the i-th node. For example, the higher the value of M_{i,j}(t), the greater the effect of the j-th node on the node output of the i-th node. In some embodiments, M_{i,j}(t) may have positive and negative values.

As shown in FIG. 5, the magnitude of M_{i,j}(t) determines the possible amount of changes to the plastic parameters α_{i,j}(t) of the neural network model 310. During an execution of the neural network model 310, the plastic parameter α_{i,j} is modified based on the node outputs of the j-th node and the node outputs of the i-th node, but the maximum amount that α_{i,j} can be modified by in that execution is determined by the component of the neuromodulatory signal M_{i,j}(t).

### Process for Executing DNP-Based Neural Network Model

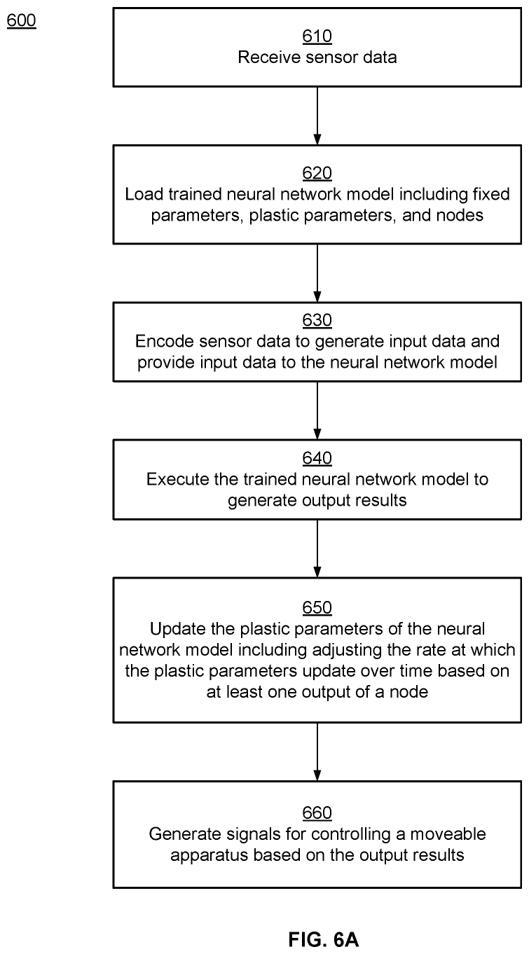

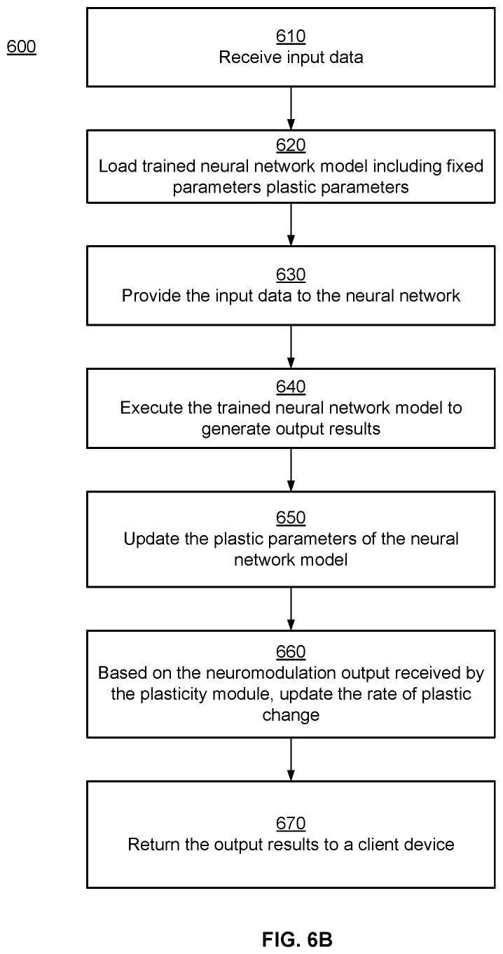

FIGS. 6A-6B illustrating the details of processes for the execution of a DNP-based model, according to various embodiments.

FIG. 6A illustrates a process for providing instructions to a moveable apparatus in response to received sensor data based on generated output results from executing a DNP-based neural network model. In some embodiments, the moveable apparatus is an autonomous vehicle configured for self-driving in traffic or a mobile robot configured to navigate in an obstacle course. The following steps are performed by the agent of the system. The agent receives 610 sensor data describing the environment of the agent. The agent loads 620 a trained neural network model including a plurality of fixed parameters, a plurality of plastic parameters, and a plurality of nodes. Each node of the plurality of nodes generates an output based on one or more inputs to the neural network model, the plurality of fixed parameters, and the plurality of plastic parameters. At least one node of the plurality of nodes generates an output further based on at least one weighted output generated by one or more other nodes of the plurality of nodes.

The agent encodes 630 the sensor data to generate input data and provides 630 the input data to the neural network model. The agent executes the trained neural network model to generate 640 outputs. The plastic parameters of the neural network are updated 650, including adjusting 650 the rate at which the plastic parameters update over time based on at least one output of a node generated by the execution 640 of the neural network model. The plastic parameters are updated according to the equations (1-4) described herein.

The agent generates 660 signals for controlling a moveable apparatus based on the output results generated by executing 640 the neural network model. The generated signals may be, for example, navigation instructions for an autonomous vehicle. These steps may be repeated by the agent until the agent reaches a final state.

In other embodiments, the neural network execution module 112 may receive other types of sensor data, for example, lidar scans captured by a lidar mounted on the moveable apparatus, camera images captured by a camera mounted on the moveable apparatus, infra-red scans, sound input, and so on and apply similar aggregation operation (e.g., averaging values) across the data points of the sensor data to transform the sensor data to lower dimensional data, thereby reducing the state complexity.

In another embodiment, the neural network execution module 112 reduces the complexity of the sensor data by performing sampling. For example, if the neural network execution module 112 receives sensor data representing intensity of sound received at 100 times per second, the neural network execution module 112 takes an average of the values received over each time interval that is 1 second long to reduce the number of data values by a factor of 100.

In an embodiment, the neural network execution module 112 extracts features from the sensor data. The features are determined based on domain knowledge associated with a problem that is being solved by the agent. For example, if the agent is playing an Atari game, the extracted features may represent specific objects that are represented by the user interface of the game. Similarly, if the agent is navigating a robot, the features may represent different objects in the environment that may act as obstacles. If the agent is navigating a self-driving car, the features may represent other vehicles driving on the road, buildings in the surroundings, traffic signs, lanes of the road and so on. The reduction of the complexity of the state space improves the computational efficiency of the processes although given sufficient computational resources, the process can be executed with the original set of states.

FIG. 6B illustrates a process for executing a DNP-based neural network model for generating output results. Examples of output results include: a recognized pattern in input data, a decision based on input data, and a prediction based on input data. For example, the DNP-based neural network model may receive an image as input data and generate output results including a score indicative of a recognized object in the image. In another embodiment, the DNP-based neural network model receives a sentence in a language and generates output results including a sentence in another language.

The following steps are performed by the agent of the system. The agent receives 610 input data, for example, from a client device. In some embodiments, the input data is sensor data from a sensor, e.g. images from an image sensor. The agent loads 620 a trained neural network model including a plurality of fixed parameters, a plurality of plastic parameters, and a plurality of nodes.

Each node of the plurality of nodes generates an output based on one or more inputs to the neural network model, the plurality of fixed parameters, and the plurality of plastic parameters. At least one node of the plurality of nodes generates an output further based on a least one weighted output generated by one or more other nodes of the plurality of nodes. The agent provides 630 the input data to the neural network model. The agent executes the trained neural network model to generate 640 output results.

The plastic parameters of the neural network are updated 650, including adjusting 650 the rate at which the plastic parameters update over time based on at least one output of a node generated by the execution 640 of the neural network model. The plastic parameters are updated according to the equations (1-4) described herein.

The agent generates 660 signals for controlling a moveable apparatus based on the output results generated by executing 640 the neural network model. These steps may be repeated by the agent until the agent reaches a final state.

In one embodiment, the agent operates a robot traversing a maze or obstacle course, generating instructions for the robot by executing a DNP-based neural network model. The agent receives a reward input signal when the reaches an associated location in the maze or obstacle course. The associated location may change between a number of episodes. For example, an episode may have a duration corresponding to 200 traversal steps taken by the robot. When the robot reaches the associated location, the agent receives the reward input signal, and the robot is subsequently moved to a random location in the maze. The DNP-based neural network model is configured to provide instructions for the robot to navigate the maze or obstacle course, such that the agent receives the reward input signal as many times as possible in a given episode.

In alternate embodiments, the agent performs word-level language modeling. The agent receives one or more words from a language and predicts a next word in a large language corpus, generating the next word by executing a DNP-based neural network model. For example, the large language corpus may be the Penn Tree Bank corpus. In some embodiments, the DNP-based neural network is a long short-term memory (LSTM) model. The DNP-based neural network is trained using supervised learning techniques for word-level language modeling.

DNP-based neural network models, as described above, are able to self-modify their configurations, adjusting the rate at which the weighted connections are updated over a number of episodes. This enables the neural network models to develop complex learning strategies. Embodiments of the DNP-based neural network model outperform models without plasticity and with non-modulated plasticity, for example, in tasks such as cue-reward association, navigating a maze, and word-level language modeling. Additionally, DNP-based neural network models can be optimized using gradient descent allowing for deep learning architectures to include DNP-based neural network models. The neural network models having several million nodes were evaluated using a perplexity measure that indicates how well a probability distribution or probability model predicts a sample. Using benchmark studies, it was found that neural networks based on the embodiments of invention perform better compared to conventional neural networks. The improvement is more noticeable for large neural networks.

### Computing System Architecture

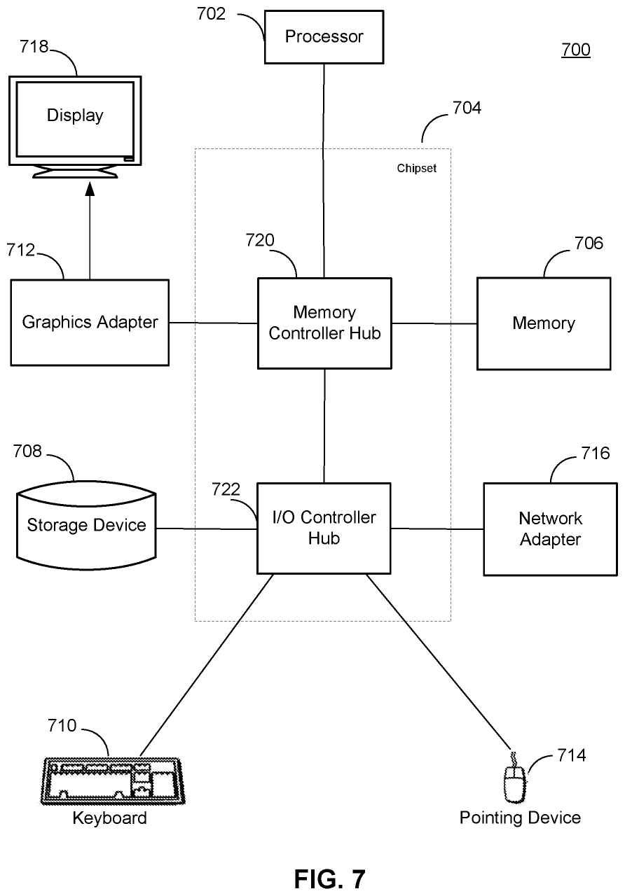

FIG. 7 is a high-level block diagram illustrating an example computer 700 suitable for use as a client device 130, application hosting server 120, or application provider system 110. The example computer 700 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, keyboard 710, pointing device 714, and network adapter 716 are coupled to the I/O controller hub 722. Other embodiments of the computer 700 have different architectures.

In the embodiment shown in FIG. 7, the storage device 708 is a non-transitory computer-readable storage medium such as a hard drive, compact disk read-only memory (CD-ROM), DVD, or a solid-state memory device. The memory 706 holds instructions and data used by the processor 702. The pointing device 714 is a mouse, track ball, touch-screen, or other type of pointing device, and is used in combination with the keyboard 710 (which may be an on-screen keyboard) to input data into the computer system 700. The graphics adapter 712 displays images and other information on the display 718. The network adapter 716 couples the computer system 700 to one or more computer networks (e.g., network 140).

The types of computers used by the entities of FIG. 1 can vary depending upon the embodiment and the processing power required by the entity. For example, the application hosting server 120 might include a distributed database system comprising multiple blade servers working together to provide the functionality described. Furthermore, the computers can lack some of the components described above, such as keyboards 710, graphics adapters 712, and displays 718.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for compressing neural networks. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

What is claimed is:

1. A computer-implemented method comprising:
receiving sensor data from one or more sensors mounted on a moveable apparatus, the sensor data describing the environment of the moveable apparatus;
loading a trained neural network model, the neural network model comprising:
a plurality of fixed parameters, wherein a fixed parameter remains unchanged during execution of the trained neural network,
a plurality of plastic parameters, wherein a plastic parameter is modified during execution of the trained neural network model,
a plurality of nodes, each node of the plurality of nodes generating an output based on one or more inputs to the neural network model, the plurality of fixed parameters, and the plurality of plastic parameters,
wherein at least one node of the plurality of nodes generates an output further based on at least one weighted output generated by one or more other nodes of the plurality of nodes,
encoding sensor data to generate input data for the neural network model;
providing the input data comprising the encoded sensor data to the neural network model;
executing the trained neural network model to generate output results, based on the input data comprising the encoded sensor data, the output results describing the environment of the moveable apparatus;
updating the plastic parameters of the neural network model, the updating comprising:
adjusting a rate at which the plastic parameters update over time based on at least one output of a node of the plurality of nodes generated by the executing the trained neural network model; and
generating signals for controlling the moveable apparatus based on the output results.

2. The computer-implemented method of claim 1, wherein the moveable apparatus is an autonomous vehicle, and wherein the generated signals include navigation instructions for the autonomous vehicle.

3. The computer-implemented method of claim 1, wherein the moveable apparatus is a robot configured to navigate through an obstacle course, wherein the generated signals control the motion of the robot.

4. The method of any of claim 1, wherein the sensor data comprises images captured by a camera mounted on the moveable apparatus.

5. The computer-implemented method of claim 1, wherein the sensor data comprises lidar scans captured by a lidar mounted on the moveable apparatus.

6. The computer-implemented method claim 1, wherein the updating the plastic parameters further comprises:
adjusting the rate at which the plastic parameters update over time based on past executions of the trained neural network model.

7. The computer-implemented method of claim 6, wherein the past executions of the trained neural network model are weighted based on a trainable decay factor.

8. The computer-implemented method of claim 1, wherein
the input data comprises a reward input, and
the at least one of the generated output results from executing the trained neural network model comprises a reward signal generated in response to the reward input being above a threshold value.

9. The computer-implemented method of claim 1, wherein the trained neural network model is one selected from a group comprising:
a long short-term memory (LSTM) model, a recurrent neural network (RNN), and a feedforward neural network.

10. The computer-implemented method of claim 1, wherein the plastic parameters are optimized using gradient descent at an execution time of the trained neural network model.

11. A computer-implemented method comprising:
loading a trained neural network model, the neural network model comprising:
a plurality of fixed parameters, wherein a fixed parameter remains unchanged during execution of the trained neural network,
a plurality of plastic parameters, wherein a plastic parameter is modified during execution of the trained neural network model,
a plurality of nodes, each of the plurality of nodes generating an output based on the one or more inputs, the plurality of fixed parameters, and the plurality of plastic parameters,
wherein at least one node of the plurality of nodes generates an output further based on at least one weighted output generated by one or more other nodes of the plurality of nodes;
providing an input data to the neural network model;
executing the trained neural network to generate output results, the output results corresponding to at least one of: a recognized pattern in the input data, a decision based on the input data, or a prediction based on the input data; and
updating the plastic parameters of the neural network model, the updating comprising:
adjusting the rate at which the plastic parameters update over time based on at least one output of a node of the plurality of nodes, the output generated by executing the trained neural network.

12. The computer-implemented method of claim 11, wherein the updating the plastic parameters further comprises:
adjusting the rate at which the plastic parameters update over time based on past executions of the trained neural network model.

13. The computer-implemented method of claim 12, wherein the past executions of the trained neural network model are weighted based on a trainable decay factor.

14. The computer-implemented method of method of claim 11, wherein
the input data comprises a reward input, and
the at least one of the generated output results from executing the trained neural network model comprises a reward signal generated in response to the reward input being above a threshold value.

15. The computer-implemented method of claim 11, wherein the plastic parameters are optimized using gradient descent at an execution time of the trained neural network model.

16. The computer-implemented method of claim 11, wherein the input data comprises an image, and wherein the generated output results comprise a recognized object in the image.

17. The computer-implemented method of claim 11, wherein the input data comprises a sentence in a language, and wherein the generated output results comprise a sentence in another language.

18. A non-transitory computer readable storage medium storing executable instructions that, when executed by one or more processors, cause the one or more processors to execute steps comprising:
receiving sensor data from one or more sensors mounted on a moveable apparatus, the sensor data describing the environment of the moveable apparatus;
loading a trained neural network model, the neural network model comprising:
a plurality of fixed parameters, wherein a fixed parameter remains unchanged during execution of the trained neural network,
a plurality of plastic parameters, wherein a plastic parameter is modified during execution of the trained neural network model,
a plurality of nodes, each node of the plurality of nodes generating an output based on one or more inputs to the neural network model, the plurality of fixed parameters, and the plurality of plastic parameters,
wherein at least one node of the plurality of nodes generates an output further based on at least one weighted output generated by one or more other nodes of the plurality of nodes,
encoding sensor data to generate input data for the neural network model;
providing the input data comprising the encoded sensor data to the neural network model;
executing the trained neural network model to generate output results, based on the input data comprising the encoded sensor data, the output results describing the environment of the moveable apparatus;
updating the plastic parameters of the neural network model, the updating comprising:
adjusting a rate at which the plastic parameters update over time based on at least one output of a node of the plurality of nodes generated by the executing the trained neural network model; and
generating signals for controlling the moveable apparatus based on the output results.

19. The non-transitory computer readable storage medium of claim 18, wherein the updating the plastic parameters further comprises:
adjusting the rate at which the plastic parameters update over time based on past executions of the trained neural network model.

20. The non-transitory computer readable storage medium of claim 19, wherein the past executions of the trained neural network model are weighted based on a trainable decay factor.
